(19) United States
(12) Patent Application Publication
(10) Pub. No.: US 2005/0256226 A1
(43) Pub. Date: Nov. 17, 2005

(54) Phosphate esters dispersants

(76) Inventors: Dean Thetford, Manchester (GB); John David Schofield, Manchester (GB); Neil Louis Simpson, Manchester (GB)

Correspondence Address: Samuel B Laferty;The Lubrizol Corporation, Patent Dept. Mail Drop 022B, 29400 Lakeland Boulevard, Wickliffe, OH, 44092-2298, US

(21) Appl. No.: 10/505,840

(22) PCT Filed: Feb. 18, 2003
(86) PCT No.: PCT/GB03/00601

§ 371 Date: Aug. 26, 2004

(30) Foreign Application Priority Data
Feb. 28, 2002 (GB) 0204638.1

(51) Int. Cl. C09D 5/00; C07F 9/02

(52) U.S. Cl. 523/161; 554/78

(57) ABSTRACT

A dispersant which comprises the reaction product of a phosphating agent such as polyphosphoric acid and a compound of formula R—OH wherein R is a residue of a polyester and/or polyether having a polymerisation terminating group and where the ratio of each phosphorus atom of the phosphating agent to RO—H is from 1.3:1 to 3:1. The dispersants are thought to be pyrophosphates.

The present invention relates to phosphate esters of a polyester, their use as dispersants for dispersing a particulate solid in a liquid medium and to millbases, paints and inks, including inks for ink jet printing containing such dispersants. The dispersants may also be used for dispersing a particulate solid in a plastics material.

Dispersants which are phosphate esters of a polyester having a terminating hydroxy group have been widely reported in the patent literature. In certain patents, such as U.S. Pat. No. 4,746,462, U.S. Pat. No. 5,130,463 and U.S. Pat. No. 5,300,255, the dispersant has been accorded a specific structure wherein from 1 to 3 of the hydroxy groups in a phosphate group are replaced by the residue of a polyester having a terminating hydroxy group. In other patent documents such as WO 97/19748, WO 97/19948, WO 97/42252, WO 98/19784, WO 99/49963, WO 99/55762 and WO 01/80987, the dispersant is defined as a phosphate ester of a defined polyester having a terminating hydroxy group. More specifically, the dispersants are defined wherein the ratio of polyester to each phosphorus atom of the phosphating agent is from 1:1 to 3:1 which, therefore, again clearly describes replacing from 1 to 3 of the hydroxy groups of the phosphate group. In all cases the dispersant can be a mixture of mono-, di- and tri-phosphate.

It has now been found that where the dispersant is prepared by using an excess of the phosphating agents, such as polyphosphoric acid, relative to the polyester having a terminating hydroxy group it exhibits superior properties such as lower millbase viscosity, higher pigment loading, superior flocculation resistance and better stability of millbases, paints and inks. Furthermore, the paint films often exhibit superior gloss, haze and colour strength and, in the case of transparent iron oxides, the paint films often exhibit higher transparency.

The precise structure of the phosphate dispersants has not been wholly elucidated but it is thought to involve polyphosphorus moieties which may include pyrophosphates.

According to the invention there is provided a dispersant (hereinafter The Dispersant) which comprises the reaction product of a phosphating agent and a compound of formula 1
R—OH 1
wherein the ratio of each atom of phosphorus in the phosphating agent to the compound of formula 1 is not less than 1.3:1, including mixtures and salts thereof;
wherein

R is the residue of a polyester and/or polyether having a polymerisation terminating group.

Preferably, the ratio of each phosphorus atom of the phosphating agent to each compound of formula 1 is not less than 1.5:1 and especially not less than 1.8:1. Although the amount of phosphating agent may be considerably in excess of the amount of compound of formula 1 there is generally no additional benefit and consequently it is preferable that the ratio of each phosphorus atom of the phosphating agent to the compound of formula 1 is not greater than 5:1, more preferably not greater than 3:1 and especially not greater than 2.5:1.

When R is the residue of a polyester and polyether it may be a random copolymer but it is preferably a block copolymer and the phosphating agent may react with a hydroxy group attached to either an ether or ester residue.

The weight-average molecular weight of R—OH can vary over a wide range depending on the nature of the liquid medium in which the dispersant is to be used. Preferably, the number-average molecular weight of R—OH is not less than 200, more preferably not less than 300 and especially not less than 500. It is also preferred that the number-average molecular weight of R—OH is not greater than 10,000, more preferably not greater than 5,000 and especially not greater than 3,000. The molecular weight of R—OH is largely dependant on the end-use of the dispersant and higher molecular weights are preferred when the dispersant is used to disperse a particulate solid in a non-polar liquid medium. Conversely, lower molecular weights of R—OH are preferred when the dispersant is used to disperse a particulate solid in a polar liquid medium; especially where the liquid medium is water, an aqueous-based liquid medium or plastics material.

The polyester and/or polyether moiety of R—OH may be attached to the polymerisation terminating group via an amino, mercaptan or preferably a hydroxy group.

The compound of formula I is preferably a compound of formula 2.
TO—(CO-A-O)ₙ(B-O)ₘ H 2
wherein

T is a polymerisation terminating group;

A is C₁₋₃₀-alkylene or C₂₋₃₀-alkenylene;

B is C₂₋₆-alkylene;

n and m are each, independently, from 0 to 500; and

n+m is not less than 4;

including salts and mixtures thereof.

The group (CO-A-O)ₙ may be the residue of a single hydroxy carboxylic acid or lactone thereof or it may be the residue of two or more different hydroxy carboxylic acids or lactones thereof. Similarly the group (B-O)ₘ may be the residue of a single alkylene oxide or it may be the residue of two or more different alkylene oxides.

The compound of formula 2 is herein after referred to as a TPE alcohol.

The polymerisation terminating group is preferably the residue of an organic hydroxy compound, T-OH. T may be aryl, heteroaryl, aralkyl, cycloalkyl or alk(en)yl, which may be linear or branched.

Preferably, T contains not greater than 50 and especially not greater than 30 carbon atoms and may carry substitutents. The nature of T depends on the end-use of the dispersant. Thus, when the dispersant is used to disperse a particulate solid in a non-polar liquid medium the number of carbon atoms in T-OH is preferably not less than 8 and especially not less than 14. When the dispersant is used to disperse a particulate solid in a polar medium the number of carbon atoms in T-OH is preferably not greater than 14 and especially not greater than 10. When the dispersant is to be used to disperse a particulate solid in an aqueous, or predominantly aqueous, liquid medium the number of carbon atoms in T-OH is preferably not greater than 10. When the liquid medium is, or contains, water, T is preferably alkyl, more preferably C₁₋₈-alkyl and especially C₁₋₄-alkyl and may be linear or branched.

The choice of T-OH is also influenced by the nature of the groups (CO-A-O)ₙ and (B-O)ₘ in order to render the dispersant compatible with the liquid medium depending on its polarity.

When T is aryl it may be polycyclic but is preferably naphthyl or phenyl and it may carry substitutents such as halogen, aryloxy, alkoxy, alkyl and styryl. Halogen may be fluorine, bromine and especially chlorine. Alkoxy is preferably C₁₋₁₈-alkoxy and may be linear or branched. Alkyl is preferably C₁₋₁₄-alkyl and may be linear or branched. Aryloxy is preferably phenoxy. Halogen is preferably fluorine, bromine and especially chlorine.

Specific examples of T-OH where T is aryl are phenol, 1-naphthol, 2-naphthol, 4-nonylphenol, 2-phenoxyphenol and 4-phenoxyphenol. 2-Naphthol is preferred.

When T is heteroaryl, it is preferably thienyl.

When T is aralkyl, it is preferably benzyl or 2-phenylethyl.

When T is cycloalkyl it is preferably C₃₋₈-cycloalkyl such as cyclopropyl, cyclopentyl and especially cyclohexyl optionally substituted by C₁₋₆-alkyl.

When T is alkyl it is preferably C₁₋₃₆-alkyl and may be linear or branched. Examples of T are methyl, ethyl, n-propyl, isopropyl, n-butyl, tert-butyl, n-hexyl, n-heptyl, n-octyl, 2-ethylbutyl 2-ethylhexyl, n-nonyl, n-decyl, n-dodecyl, n-tetradecyl, n-hexadecyl, n-octadecyl, 3-heptyl, 3,5,5-trimethylhexyl, 3,7-dimethyloctyl and the residue of a so-called Guerbet alcohol such as those which are commercially available under the trade name Isofol (ex Condea GmbH) including mixtures thereof. Specific examples of Guerbet alcohols are Isofol 12, 14T, 16, 18T, 18E, 20, 24, 28, 32T and 36.

When T is alkenyl it preferably contains not less than 4 and especially not less than 8 carbon atoms such as oleyl.

When T is alkyl it may be substituted by C₁₋₆-alkoxy or halogen such as fluorine and chlorine. However, it is preferred that T is unsubstituted alkyl.

It is preferred, generally, that T is alkyl which may be linear or branched and is especially C₁₋₂₀-alkyl.

When A is alk(en)ylene it may be linear or branched and includes mixtures. The choice of hydroxy carboxylic acid or lactone from which (CO-A-O) is derived depends on the end use of the dispersant. Thus, where the dispersant is intended to disperse a particulate solid in a non-polar liquid medium, A preferably contains not less than 8 carbon atoms. When the dispersant is intended to disperse a particulate solid in a polar liquid medium, A preferably contains not greater than 10, more preferably not greater than 8 and especially not greater than 6 carbon atoms. The alk(en)ylene group may also be substituted, especially by C₁₋₆-alkyl groups which may be linear or branched. Examples of hydroxy carboxylic acids from which (CO-A-O)ₙ is derived are glycolic acid, 5-hydroxyvaleric acid, 6-hydroxy hexanoic acid, ricinoleic acid, 12-hydroxystearic acid, 12-hydroxy dodecanoic acid, 5-hydroxy dodecanoic acid, 5-hydroxy decanoic acid and 4-hydroxy decanoic acids. Examples of lactones from which (CO-A-O) is derived are β-propiolactone, δ-valerolactone, ε-caprolactone and the C₁₋₆-alkyl substituted ε-caprolactone derivatives such as 7-methyl, 3-methyl, 6-methyl, 4-methyl, 5-methyl, 5-tert-butyl, 4,6,6-trimethyl and 4,4,6-trimethyl ε-caprolactone, including mixtures thereof. ε-Caprolactone, δ-valerolactone and 7-methyl ε-caprolactone are the preferred lactones.

Preferably, (CO-A-O)ₙ is derivable from one or two different hydroxy carboxylic acids or lactones thereof. Particularly useful dispersants are those where (CO-A-O)ₙ is derived from 12-hydroxystearic acid optionally in combination with ε-caprolactone, ricinoleic acid optionally in combination with ε-caprolactone and ε-caprolactone optionally in combination with either glycolic acid or δ-valerolactone.

When the group (CO-A-O)ₙ is derivable from a mixture of ε-caprolactone together with glycolic acid, δ-valerolactone and/or alkyl substituted ε-caprolactone the ε-caprolactone is preferably present in molar excess relative to the other lactone(s).

When B is C₂₋₆-alkylene it may be linear or branched and is especially C₂₋₄-alkylene. Preferably (BO) is the residue of an alkylene oxide such as ethylene oxide (EO), propylene oxide (PO) or butylene oxide (BuO), including mixtures thereof. When (BO)ₘ is derived from two or more different alkylene oxides the copolymer may be a random or preferably block polymer. When the residue (B-O)ₘ is or contains BuO as repeat unit it is preferably derived from poly(tetrahydrofuran). The choice of alkylene oxide depends largely on the intended end-use of the dispersant. Thus, when the dispersant is intended to disperse a particulate solid in a polar liquid medium, such as water, it is preferred that (BO)ₘ is derived from EO, optionally containing up to 20 mole % PO. When the dispersant is intended to disperse a particulate solid in a non-polar liquid medium the group (BO)ₘ is preferably derived from BuO or preferably PO optionally containing up to 20 mole % EO.

It will be obvious to the skilled addressee that variants on the polyester/polyether chain represented by (CO-A-O)ₙ (BO)ₘ may be made where repeat units represented by (BO) interrupt the chain represented by (CO-A-O)ₙ and/or repeat units represented by (CO-A-O) interrupt the chain represented by (BO)ₘ. Such variants also fall within the scope of the present invention.

The polyether chain represented by (BO)ₘ may also contain ester or urethane groups where it is desirable to build the (BO)ₘ polyether chain from smaller polymers or oligomers which may be the same or different. For example, the polyether chain represented by (BO)ₘ may be made by joining the two polyether chain segments by reaction with a dicarboxylic acid or anhydride or a polyisocyanate such as a diisocyanate. Examples of such dicarboxylic acids, anhydrides or isocyanates are 1,6-hexyldicarboxylic acid, terephthalic acid, phthalic anhydride, 1,6-hexyl diisocyanate and tolyl diisocyanate. Preferably, the chain segment represented by (BO)ₘ is free from the residue of a dicarboxylic acid or isocyanate.

The polyether chain represented by (BO)ₘ may be directly attached to the polymerisation terminating group. Examples of such polyethers are polyethylene glycol mono C₁₋₁₀-alkyl ethers, preferably the mono methyl ethers, more preferably those mono-alkyl ethers having a number average molecular weight of less than 3000 and especially those having a molecular weight of less than 2000. Monoalkyl ethers having a number average molecular weight which is less than 1500 are especially useful. Other examples are the mono-alkyl ethers of polypropylene glycol and the mono alkyl ethers of polyethylene glycol/polypropylene copolymers where the alkyl group may be attached to either a PO or EO residue.

The ratio of n:m may vary over a wide range depending on the intended use of the dispersant. Thus, when the dispersant is intended for dispersing a particulate solid in an aqueous or predominantly aqueous liquid medium in one preferred class of dispersants n is zero and m is preferably not greater than 100. Particularly important dispersants for aqueous media are where TO- is the residue of 2-naphthol, alkylphenol, styrenated phenol or phenyl phenol. In another preferred class of dispersants for use in aqueous or predominantly aqueous liquid media (CO-A-O) is derived from ε-caprolactone optionally in admixture with δ-valerolactone, BO is the residue of ethylene oxide and the molecular weight of TO-(CO-A-O)ₙ is less than the molecular weight of (BO)ₘ. Particularly important dispersants of this class for use in aqueous liquid media are those derived from ethylene glycol monomethyl ether and particularly those where m+n is not greater than 200 and especially not greater than 100.

One important class of dispersants for use in polar liquid media other than water is where m is zero, (CO-A-O)ₙ is derived from ε-caprolactone optionally in admixture with glycolic acid and/or δ-valerolactone and where n is preferably not greater than 100, more preferably not greater than 50 and especially not greater than 20. Another important class of dispersant for use in polar liquid media is where (CO-A-O)ₙ is derived from ε-caprolactone optionally in admixtiure with glycolic acid and/or δ-valerolactone, BO is derived from ethylene oxide and/or propylene oxide and where the molecular weight of RO(CO-A-O)ₙ is greater than the molecular weight of (BO)ₘ, m+n is preferably not greater than 100 and especially not greater than 50. Particularly important dispersants of this class are those derived from a polyethylene glycol mono alkyl ether reacted with ε-caprolactone optionally in the presence of glycolic acid and/or δ-valerolactone.

When the dispersant is intended for use in a non-polar liquid media an important class of dispersant is those where (BO)ₘ is derived from PO and/or BuO. A particularly preferred class of dispersant for use in non-polar liquid media is where m is zero and (CO-A-O)ₙ is derived from a C₈₋₂₄-alk(en)yl hydroxy carboxylic acid such as 12-hydroxystearic or ricinoleic acid optionally containing ε-caprolactone.

In general, monohydric alcohols of formula R—OH which can be used to make dispersants according to the invention may be any of those disclosed in U.S. Pat. No. 4,746,462, U.S. Pat. No. 5,130,463, U.S. Pat. No. 5,300,255, WO 97/19748, WO 97/19948, WO 97/42252, WO 98/19784, WO 99/49963, WO 99/55762 and WO 01/80987. These are all incorporated herein by reference.

The compounds of formula 1 which are used to make the dispersants according to the invention may be made by any method known to the art. This includes reacting a polymerisation terminating compound such as T-OH under anhydrous conditions with one or more alkylene oxides, preferably in an inert atmosphere and preferably in the presence of an alkaline catalyst or a Lewis acid catalyst. The polyether so obtained may optionally be reacted with one or more hydroxy carboxylic acids or lactones thereof preferably in an inert atmosphere and preferably in the presence of an esterfication catalyst to give a polyether/polyester block copolymer where the polymerisation terminating group is attached to the polyether moiety. Alternatively, the polymerisation terminating compound may be first reacted with one or more hydroxy carboxylic acids or lactones thereof to give a polyester having a terminating polymerisation group and this polyester may then be optionally reacted with one or more alkylene oxides. The conditions required for making the polyester are described inter alia in WO 98/19784 and WO 01/80987.

The reaction between the compound of formula 1 and the phosphating agent is typically carried out at a temperature from 40° C. to 120° C., preferably in an inert atmosphere or optionally in an inert solvent. Preferably, the temperature is above 60° C. and especially above 80° C. In order to minimise discoloration of the dispersant the temperature is preferably not greater than 100° C.

Thus, according to a further aspect of the invention there is provided a process for making a phosphate ester dispersant which comprises reacting a compound of formula 1 with a phosphating agent at a temperature from 40° C. to 120° C. characterised in that the ratio of each phosphorus atom of the phosphating agent to the compound of formula 1 is not less than 1.3:1. The ratio of each phosphorus atom of the phosphating agent to the compound of formula 1 is preferably not greater than 5:1 and more preferably not greater than 3:1 and especially not greater than 2.5:1.

Examples of phosphating agents are POCl₃, P₂O₅ and especially polyphosphoric acid.

Examples of suitable inert solvents are aliphatic hydrocarbons such as octane, petroleum ethers, ligroin, mineral spirits and kerosene; aromatic hydrocarbons such as benzene, toluene and xylene; halogenated aliphatic hydrocarbons such as trichloroethane, tetrachloroethane and aromatic chlorinated hydrocarbons such as di- and tri-chlorobenzene. It is preferred, however, that the reaction between the compound of formula 1 and the phosphating agent is carried out in the absence of an inert solvent.

The inert atmosphere may be provided by any one of the inert gases of the Periodic Table but is preferably nitrogen.

When the phosphating agent is POCl₃, it is preferable to carry out the reaction with the compound of formula 1 in the presence of an organic base, for example a tertiary amine such as triethylamine, pyridine, 2,6-lutidine or 1,8-diaza-bicyclo-(5.4.0) undec-7-ene.

As disclosed hereinbefore, the dispersants according to the invention may be present in the form of a salt which may be the salt of an inorganic or organic cation. Examples of suitable inorganic cations are the alkali metals such as sodium, potassium and lithium and the alkali earth metals such as calcium, barium and magnesium. The dispersant may also be present in the form of an ammonium salt. Examples of organic cations are primary, secondary and tertiary mono- and poly-amines, especially those containing from 1 to 30 carbon atoms such as methylamine, ethylamine, propylamine, butylamine, hexlamine, octylamine, 2-ethylhexylamine, dodecylamine, octadecylamine, oleylamine, diethylamine, dibutylamine, distearylamine, triethylamine, tributylamine, dimethyloctylamine, dimethyidecylamine, dimethyldodecylamine, dimethyl-tetradecylamine, dimethylhexadecylamine, dimethyloctadecylamine, dimethyloleylamine, dilauryl monomethylamine, trioctylamine, dimethylaniline, ethylenediamine, propylenediamine, hexamethyldiamine and stearylpropylene diamine; quaternary ammonium cations such as octadecyl trimethyl ammonium and dioctadecyl dimethyl ammonium; and alkanolamine such as ethanolamine, diethanolamine, triethanolamine, dimethylethanolamine, diethyl ethanolamine, propanolamine and ethoxylates of fatty amines, including mixtures of amines. The choice of salt depends largely on the nature of the particulate solid and the nature of the liquid medium. Where the liquid medium is water or a polar liquid medium and the particulate solid is a pigment, useful effects have been obtained where the dispersant is a salt of diethanolamine.

The dispersant may also be subsequently reacted with an organic hydroxy compound to form a mixed ester. Examples of suitable hydroxy compounds are C₁₋₃₀-aliphatic alcohols such as ethanol, butanol, hexanol, decanol, dodecanol, cetyl alcohol, oleyl alcohol and stearyl alcohol, including mixtures thereof. It is, however, preferred that the dispersant is not subsequently reacted with an organic hydroxy compound.

The preparation of the salt or reaction with an organic hydroxy compound may be carried out under similar conditions to the reaction between the compound of formula 1 and the phosphating agent and may be carried out without prior isolation of the reaction product of the compound of formula 1 and phosphating agent.

As noted hereinbefore, the dispersants are particularly useful for dispersing a particulate solid in a liquid medium.

According to a further aspect of the invention there is provided a composition comprising a particulate solid and The Dispersant.

According to a still further aspect of the invention there is provided a dispersion comprising a The Dispersant, a particulate solid and a liquid medium.

The solid present in the dispersion may be any inorganic or organic solid material which is substantially insoluble in the liquid medium at the temperature concerned and which it is desired to stabilise in a finely divided form therein.

Examples of suitable solids are pigments for solvent inks; pigments, extenders and fillers for paints and plastics materials; dyes, especially disperse dyes; optical brightening agents and textile auxiliaries for solvent dyebaths, inks and other solvent application systems; solids for oil-based and invert-emulsion drilling muds; dirt and solid particles in dry cleaning fluids; particulate ceramic materials; magnetic materials and magnetic recording media, fire retardants such as those used in plastics materials, metal salts such as carbonates and oxides which are used in the cement industry and biocides, agrochemicals and pharmaceuticals which are applied as dispersions in organic media.

A preferred solid is a pigment from any of the recognised classes of pigments described, for example, in the Third Edition of the Colour Index (1971) and subsequent revisions of, and supplements thereto, under the chapter headed “Pigments”. Examples of inorganic pigments are titanium dioxide, zinc oxide, Prussian blue, cadmium sulphide, iron oxides, vermilion, ultramarine and the chrome pigments, including chromates, molybdates and mixed chromates and sulphates of lead, zinc, barium, calcium and mixtures and modifications thereof which are commercially available as greenish-yellow to red pigments under the names primrose, lemon, middle, orange, scarlet and red chromes. Examples of organic pigments are those from the azo, disazo, condensed azo, thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes. Carbon black, although strictly inorganic, behaves more like an organic pigment in its dispersing properties. Preferred organic pigments are phthalocyanines, especially copper phthalocyanines, monoazos, disazos, indanthrones, anthranthrones, quinacridones and carbon blacks.

Other preferred solids are: extenders and fillers such as talc, kaolin, silica, barytes and chalk; particulate ceramic materials such as alumina, silica, zirconia, titania, silicon nitride, boron nitride, silicon carbide, boron carbide, mixed silicon-aluminium nitrides and metal titanates; particulate magnetic materials such as the magnetic oxides of transition metals, especially iron and chromium, e.g. gamma-Fe₂O₃, Fe₃O₄, and cobalt-doped iron oxides, calcium oxide, calcium carbonate, magnesium carbonate, ferrites, especially barium ferrites; and metal particles, especially metallic iron, nickel, cobalt and alloys thereof; agrochemicals such as the fungicides flutriafen, carbendazim, chlorothalonil and mancozeb and fire retardants such as aluminium trihydrate and magnesium hydroxide.

It is especially preferred that the particulate solid is an inorganic pigment, extender or filler.

The liquid may be water or an organic medium, including mixtures thereof.

The organic medium present in the dispersions of the invention is preferably a polar organic medium or a substantially non-polar aromatic hydrocarbon or halogenated hydrocarbon. By the term “polar” in relation to the organic medium is meant an organic liquid or resin capable of forming moderate to strong bonds as described in the article entitled “A Three Dimensional Approach to Solubility” by Crowley et al in Journal of Paint Technology, Vol. 38, 1966, at page 269. Such organic media generally have a hydrogen bonding number of 5 or more as defined in the abovementioned article.

Examples of suitable polar organic liquids are amines, ethers, especially lower alkyl ethers, organic acids, esters, ketones, glycols, alcohols and amides. Numerous specific examples of such moderately strongly hydrogen bonding liquids are given in the book entitled “Compatibility and Solubility” by Ibert Mellan (published in 1968 by Noyes Development Corporation) in Table 2.14 on pages 39-40 and these liquids all fall within the scope of the term polar organic liquid as used herein.

Preferred polar organic liquids are dialkyl ketones, alkyl esters of alkane carboxylic acids and alkanols, especially such liquids containing up to, and including, a total of 6 carbon atoms. As examples of the preferred and especially preferred liquids there may be mentioned dialkyl and cycloalkyl ketones, such as acetone, methyl ethyl ketone, diethyl ketone, di-isopropyl ketone, methyl isobutyl ketone, di-isobutyl ketone, methyl isoamyl ketone, methyl n-amyl ketone and cyclohexanone; alkyl esters such as methyl acetate, ethyl acetate, isopropyl acetate, butyl acetate, ethyl formate, methyl propionate, methoxy propylacetate and ethyl butyrate; glycols and glycol esters and ethers, such as ethylene glycol, 2-ethoxyethanol, 3-methoxypropylpropanol, 3-ethoxypropylpropanol, 2-butoxyethyl acetate, 3-methoxypropyl acetate, 3-ethoxypropyl acetate and 2-ethoxyethyl acetate; alkanols such as methanol, ethanol, n-propanol, isopropanol, n-butanol and isobutanol and dialkyl and cyclic ethers such as diethyl ether and tetrahydrofuran.

The substantially non-polar, organic liquids which may be used, either alone or in admixture with the aforementioned polar solvents, are aromatic hydrocarbons, such as toluene and xylene, aliphatic hydrocarbons such as hexane, heptane, octane, decane, petrolium distillates such as white spirit, mineral oils, vegetable oils and halogenated aliphatic and aromatic hydrocarbons, such as trichloro-ethylene, perchloroethylene and chlorobenzene.

Examples of suitable polar resins, as the medium for the dispersion form of the present invention, are film-forming resins such as are suitable for the preparation of inks, paints and chips for use in various applications such as paints and inks. Examples of such resins include polyamides, such as Versamid™ and Wolfamid™, and cellulose ethers, such as ethyl cellulose and ethyl hydroxyethyl cellulose. Examples of paint resins include short oil alkyd/melamine-formaldehyde, polyester/melamine-formaldehyde, thermosetting acrylic/melamine-formaldehyde, long oil alkyd and multi-media resins such as acrylic and urea/aldehyde.

The resin may also be a plastics material such as an unsaturated polyester resin including the so-called sheet moulding compounds and bulk moulding compounds which may be formulated with reinforcing fibres and fillers. Such moulding compounds are described in DE 3,643,007 and the monograph by P F Bruins entitled “Unsaturated Polyester Technology”, Gordon and Breach Science publishers, 1976, pages 211 to 238. Examples of polyester resins are those where an unsaturated polyester resin is copolymerised with polystyrene or styrene-butadiene copolymer and especially those containing calcium carbonate, magnesium oxide or aluminium hydroxide. The resin may also be an acrylic, styrene-acrylic or urethane-acrylic resin.

If desired, the dispersions may contain other ingredients, for example resins (where these do not already constitute the organic medium) binders, fluidising agents (such as those described in GB-A-1508576 and GB-A-2108143), anti-sedimentation agents, plasticisers, levelling agents and preservatives.

The dispersions typically contain from 5 to 95% by weight of the solid, the precise quantity depending on the nature of the solid and the quantity depending on the nature of the solid and the relative densities of the solid and the organic medium. For example, a dispersion in which the solid is an organic material, such as an organic pigment, preferably contains from 15 to 60% by weight of the solid whereas a dispersion in which the solid is an inorganic material, such as an inorganic pigment, filler or extender, preferably contains from 40 to 90% by weight of the solid based on the total weight of dispersion.

The dispersion is preferably prepared by milling the solid in the organic liquid at a temperature which is not greater than 40° C. and especially not greater than 30° C.

The dispersion may be obtained by any of the conventional methods known for preparing dispersions. Thus, the solid, the liquid medium and The Dispersant may be mixed in any order, the mixture then being subjected to a mechanical treatment to reduce the particles of the solid to an appropriate size, for example by ball milling, bead milling, gravel milling or plastic milling until the dispersion is formed. Alternatively, the solid may be treated to reduce its particle size independently or in admixture with either the liquid medium or The Dispersant, the other ingredient or ingredients then being added and the mixture being agitated to provide the dispersion.

If the composition is required in dry form, the liquid medium is preferably volatile so that it may be readily removed from the particulate solid by a simple separation means such as evaporation. It is preferred, however, that the dispersion comprises the liquid medium.

If the dry composition consists essentially of The Dispersant and the particulate solid, it preferably contains at least 0.2%, more preferably at least 0.5% and especially at least 1.0% dispersant based on weight of the particulate solid. Preferably the dry composition contains not greater than 100%, preferably not greater than 50%, more preferably not greater than 20% and especially not greater than 10% by weight based on the weight of the particulate solid.

As described hereinbefore, the dispersants of the invention are particularly suitable for preparing mill-bases where the particulate solid is milled in a liquid medium in the presence of both a particulate solid and a film-forming binder resin.

Thus, according to a still further aspect of the invention there is provided a millbase comprising a particulate solid, The Dispersant and a film-forming binder resin.

Typically, the millbase contains from 20 to 70% by weight particulate solid based on the total weight of the mill-base. Preferably, the particulate solid is not less than 30 and especially not less than 50% by weight of the mill-base.

The amount of resin in the mill-base can vary over wide limits but is preferably not less than 10%, and especially not less than 20% by weight of the continuous/liquid phase of the mill-base. Preferably, the amount of resin is not greater than 50% and especially not greater than 40% by weight of the continuous/liquid phase of the mill-base.

The amount of dispersant in the mill-base is dependent on the amount of particulate solid but is preferably from 0.5 to 5% by weight of the mill-base.

Dispersions and mill-bases containing the dispersants of the invention are particularly suitable for use in paints, especially high solid paints, inks, especially flexographic, gravure and screen inks, inks for non-impact ink jet printing, and non-aqueous ceramic processes, especially tape-coating, doctor blade, extrusion and injection moulding type processes.

The Dispersants may also be used in paper making and as a thinner in aqueous hydraulic binders such as cements, plaster, calcium sulphate, calcium carbonate, calcium oxide, to give more dense structures after hardening of the hydraulic binder. The Dispersants may also be used in making ceramics, electronic devices such as resistors and capacitors, as fluidisers in drilling muds, as detergents in dirt removal especially in the textile coloration and cleaning industry and also for metal cleaning and rust conversion/prevention.

The invention is further illustrated by the following examples wherein all references to amounts are in parts by weight unless indicated to the contrary.

### EXAMPLE 1

### Do 1, Cap 9.5, Val 3.5 1:2P, DEA

Dodecanol (11.86 parts, 0.064M ex Aldrich), ε-caprolactone (69.0 parts, 0.604M ex Aldrich) and δ-valerolactone (22.3 parts, 0.227M ex Fluka) were stirred together at 150° C. under nitrogen. Zirconium butylate (0.3 parts ex Fluka) was added and the reactants were stirred under nitrogen for 6 hours at 185-190° C. The resultant pale yellow liquid was cooled to 90-95° C. Polyphosphoric acid (10.76 parts, 83% w/w P₂O₆ ex Aldrich) was added and the reactants were stirred under nitrogen for 6 hours at 90-95° C. giving a yellow liquid which formed a beige wax at 25° C. (110 parts). The beige wax had an Acid Value of 68.2 mg KOH/gm.

The above beige wax (50 parts) was stirred under nitrogen at 90-95° C. for 6 hours with diethanolamine (6.07 parts) giving a clear viscous liquid which, after cooling at 25° C., gave a cream wax (55 parts). This is Dispersant 1.

### COMPARATIVE EXAMPLE A

### Do 1, Cap 9.5, Val 3.5 1.35:1P, DEA

The dodecanol, ε-caprolactone, δ-valerolactone polyester was prepared as described in Example 1. This polyester (35 parts) and polyphosphoric acid (1.37 parts, 83% w/w P₂O₅) were stirred under nitrogen for 6 hours at 90-95° C. The resultant phosphate ester had an Acid Value of 26.60 mg KOH/gm. Diethanolamine (1.70 parts) was added and the reaction was continued by stirring under nitrogen for 2 hours at 90-95° C. The diethanolamine salt of the phosphate ester was obtained as a soft white solid after cooling to 25° C. (35 parts). This is Dispersant A.

### EXAMPLE 2

### Oc 1, Cap 11 1:2P

Octanol (6.22 parts, 0.048M ex Aldrich) and ε-caprolactone (60 parts, 0.53M ex Aldrich) were stirred under nitrogen at 150° C. Zirconium butylate (0.3 parts ex Fluka) was added and the reactants were stirred under nitrogen for 10 hours at 175-180° C. After cooling to 25° C., the polyester was obtained as a white wax (65 parts).

The above white wax (30 parts) and polyphosphoric acid (3.7 parts 83% w/w P₂O₅) were stirred at 90-95° C. under nitrogen for 6 hours giving a golden liquid which on cooling to 25° C. formed a beige wax (33 parts) having an Acid Value of 77.68 mg KOH/gm. This is Dispersant 2.

### COMPARATIVE EXAMPLE B

### Oc 1, Cap 11 1.35:1P

The polyester white wax from Example 2 (30 parts) was stirred under nitrogen for 6 hours at 90-95° C. together with polyphosphoric acid (1.37 parts, 83% w/w P₂O₅). This gave a clear liquid which after cooling to 25° C. formed a white wax (31 parts) with an Acid Value of 33.43 mg KOH/gm. This is Dispersant B.

### EXAMPLES 3 and 4 WITH COMPARATIVE EXAMPLES C AND D

The dispersant (0.25 parts) was dissolved in a 4:1 mixture of methoxypropylacetate and n-butanol (6.75 parts) with warming as necessary. After cooling to 20° C., 3 mm diameter glass beads (17 parts) and transparent iron oxide pigment (3 parts Sicotrans Red L2817 ex BASF) were added. The pigment was dispersed by shaking for 16 hours on a horizontal shaker after which the beads were separated and the viscosity of the dispersion was assessed by manual shaking using an arbitrary scale of A to E (good to poor). The results are given in Table 1 below.

TABLE 1

| Example | Dispersant | Viscosity |
|---|---|---|
| 3 | 1 | A |
| C | A | C |
| 4 | 2 | A |
| D | B | B/C |

When Examples 3 and C were repeated except using 3.5 parts red pigment and 6.25 parts solvent mixture in place of the amounts used in these two Examples the viscosity values were A and D, respectively.

### EXAMPLES 5 AND 6 AND COMPARATIVE EXAMPLES E AND F

Examples 3, 4, C and D were repeated except using 0.15 parts dispersant, 7.5 parts white pigment (Tioxide TR 92) and 2.35 parts solvent mixture in the place of the red pigment and amounts used in Examples 3 and 4. The results are given in Table 2 below.

TABLE 2

| Example | Dispersant | Viscosity |
|---|---|---|
| 5 | 1 | A |
| E | A | B |
| 6 | 2 | A/B |
| F | B | B/C |

Example 5 was repeated except using 0.2 parts Dispersant A, 7.5 parts of Tioxide TR 92 and 2.3 parts mixed solvent and was compared with a dispersion wherein the 0.2 parts of Dispersant A was replaced with 0.19 parts Dispersant A with 0.01 parts orthophosphoric acid. It was also compared with a dispersion containing 0.19 parts Dispersant A, 0.01 part polyphosphoric acid, 8.0 parts Tioxide TR 92 and 2.3 parts mixed solvent. In all three cases the viscosity of the dispersion was assessed as B. These data indicate that the improved dispersion properties of the dispersants is not attributable to the presence of free phosphoric acid or free polyphosphoric acid.

### Preparation of Polyalkylene Glycol Mono Alkyl Ethers

The following mono alkyl ethers were prepared using the method described in EP 863795.

| Intermediate | |
|---|---|
| 1 | MeO PEG (350) + 2PO |
| 2 | MeO PEG (550) + 3PO |
| 3 | MeO PEG (550) + 4PO |
| 4 | MeO PEG (750) + 3PO |
| 5 | MeO PEG (750) + 5PO |
| 6 | MeO PEG (750) + 8PO |
| 7 | MeO PEG (2000) + 5PO |

PEG represents a polyethylene glycol chain where the appropriate number average molecule weight is given in parentheses. PO represents propylene oxide where the preceding number indicates the number of repeat units.

### Preparation of Polyether Dispersant

### EXAMPLE 7

### MeO PEG (350)+2PO 1:2P

Intermediate 1 (70 parts; 0.15M) and polyphosphoric acid (83% P₂O₅, 0.181M, ex Fluka) were stirred at 90-95° C. under nitrogen for 6 hours to give a dark brown liquid (92 parts). This is Dispersant 3. The ratio of phosphorous atoms to each polyester chain is 2:1.

### EXAMPLES 8 TO 13

Example 7 was repeated except using different polyether chains as indicated in Table 3 below where the ratio of phosphorus atoms in the phosphating agent to polyether chain is as indicated.

TABLE 3

| | Inter- | Dis- | | Ratio of P to |
|---|---|---|---|---|
| Example | mediate | persant | Polyether chain | Polyether |
| 8 | 2 | 4 | MeO PEG (550) + 3PO | 2.86:1 |
| 9 | 3 | 5 | MeO PEG (550) + 4PO | 2.67:1 |
| 10 | 4 | 6 | MeO PEG (750) + 3PO | 2:1 |
| 11 | 5 | 7 | MeO PEG (750) + 5PO | 2:1 |
| 12 | 6 | 8 | MeO PEG (750) + 8PO | 2:1 |
| 13 | 7 | 9 | MeO PEG (2000) + 5PO | 2:1 |

### EXAMPLES 14 TO 19

### Preparation of Aqueous Paints

Pigment dispersion were prepared by milling a mixture of transparent red iron oxide pigment (389.08 parts Cookson Red AC 1005 ex Cookson), Dispersant 31.13 part), Humectant GRB2 (39.96 parts ex Avecia), Proxel BD20 biocide (1.06 parts ex Avecia), Densil P fungicide (1.06 pars ex Avecia), 0.12 parts Rhodaline 6681 defoamer (ex Rhodia) and water (245.13 parts) in a Dispermat SL mixer at 36° C. for 1 hour in the presence of 1 mm diameter glass beads (560 parts). The beads were then separated and paints prepared by diluting 8 parts dispersion with 4 parts water and mixing this diluted dispersion with a (80:20) mixture of an alkyd resin (Setal 6306 SS-60 ex Akzo Nobel) and melamine formaldahyde resin (Cymel-350 ex Dyno-Cytec) (8 parts) diluted with water (4 parts). The resultant paint was applied to a Black/White card by K-bar to give a film thickness of 100 microns. The paint was allowed to dry for 30 minutes and then baked at 120° C. for 30 minutes. The glass and haze of the aqueous paints are recorded below in Table 4.

TABLE 4

Gloss

| Example | Dispersant | 60° | 20° | Haze |
|---|---|---|---|---|
| 14 | 3 | 91.0 | 63.9 | 339 |
| 15 | 4 | 97.8 | 89.2 | 93 |
| 16 | 5 | 96.2 | 83.0 | 170 |
| 17 | 6 | 96.9 | 78.4 | 215 |
| 18 | 7 | 96.5 | 81.2 | 182 |
| 19 | 8 | 97.8 | 88.0 | 97 |

### EXAMPLES 20 AND 21 WITH COMPARATIVE EXAMPLES G and H

### Effect of Overphosphation

Examples 14 to 19 were repeated except that the dispersion used as a millbase made using Cookson Red AC 1000 (77.83 parts), Dispersant (6.23 parts), Humectant GRB2 (8.00 parts), Rhodaline 6681 (0.1 parts) and water (49.34 parts).

The results are given in Table 5 below. In these examples the degree of phosphation of the polyether MeO PEG (550)+3PO has been varied.

TABLE 5

| | Ratio of P to | Gloss | | | |
|---|---|---|---|---|---|
| Example | Polyether | 60° | 20° | Haze | % Transparency |
| G | 1:1.25 | 76.6 | 40.1 | 352 | 0 |
| H | 1:1 | 80.2 | 48.2 | 301 | −4 |
| 20 | 1.3:1 | 89.3 | 67.2 | 269 | +3 |
| 21 | 2:1 | 94.2 | 76.4 | 216 | +3-4 |

### Footnote to Table 5

Comparative Examples G and H contain a high ratio of polyether chain to Phosphorus, e.g. the ratio of each phosphorus atom of the phosphating agent to polyether in Example G is 1:1.25.

Examples 20 and 21 contain a high ratio of phosphorus atom of the phosphating agent to each polyether chain, e.g. the ratio of phosphorus atoms in the phosphating agent to polyether chain in Example 20 is 1.3:1.

These examples clearly show that the gloss is increased by using a higher ratio of phosphating agent to polyether chain. These dispersants are thought to contain a pyrophosphate moiety

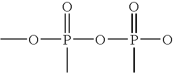

The transparency of the resultant paint films has also been compared using Comparative Example G as internal control. Those paints containing an overphosphated dispersant exhibit higher transparency than those which are underphosphated as described in EP 863795.

The viscosity of the dispersions used as millbases in Examples 20 and 21 and Comparative Examples G and H have also been measured at 20° C. using a TA Instruments Viscometer fitted with a 2 cm steel plate at a 50 micron gap. The viscosity at a shear rate of 37.6 sec⁻¹ is given in Table 6.

TABLE 6

| Ratio of P to Polyether | Viscosity (Pas) |
|---|---|
| 1:1.25 | 3.889 |
| 1:1 | 1.639 |
| 1.3:1 | 0 |
| 2:1 | 0 |

The data in Table 6 shows that the overphosphated dispersants exhibit significantly lower viscosity compared with the dispersants made as described in EP 863795.

### EXAMPLES 22 AND 23 WITH COMPARATIVE EXAMPLES

The Dispersant was dissolved in a 4:1 mixture of methoxy propylacetate and n-butanol in the amounts shown in Table 5 below, with heating as necessary. After cooling to 20° C., 3 mm diameter glass beads (17 parts) were added together with pigment and the mixture was milled in a horizontal shaker for 16 hours. The beads were then removed and the fluidity of the resulting dispersion was assessed using an arbitrary scale A to D (good to poor). The results are given in Table 7 below.

TABLE 7

| | | | Amount | Amount | Amount | |
|---|---|---|---|---|---|---|
| Exam- | Dis- | Amount of | of Red | of White | of | |
| ple | persant | Dispersant | Pigment | Pigment | Solvent | Fluidity |
| 22 | 1* | 0.25 | 3 | | 6.75 | A |
| 23 | 1 | 0.25 | 3 | | 6.75 | A |
| L | I | 0.25 | 3 | | 6.75 | C |
| 24 | 1 | 0.25 | 3.5 | | 6.25 | A/B |
| M | I | 0.25 | 3.5 | | 6.25 | D |
| 25 | 1 | 0.25 | 4 | | 5.75 | B |
| 26 | 1* | 0.2 | | 7.5 | 2.3 | A |
| 27 | 1 | 0.2 | | 7.5 | 2.3 | A |
| N | I | 0.2 | | 7.5 | 2.3 | B |
| 28 | 1 | 0.15 | | 7.5 | 2.35 | A |
| 0 | I | 0.15 | | 7.5 | 2.35 | B |
| 29 | 1 | 0.1 | | 7.5 | 2.4 | B |
| P | I | 0.1 | | 7.5 | 2.4 | C |
| 30 | 1 | 0.2 | | 7.5 | 1.8 | D |
| Q | J** | 0.19 | | 7.5 | 2.3 | B |
| R | K** | 0.19 | | 7.5 | 2.3 | B |

### Footnote to Table 7

Red Pigment is Sicotrans Red L2817 ex BASF

White Pigment is Tioxide TR92 ex Tioxide

Dispersant 1* is the free acid form of Dispersant 1 described in Example 1 prior to converting to the diethanolamine salt.

Dispersant I is identical to Dispersant 1 except that the ratio of phosphorus atom in the phosphating agent to polyester chain is 1:1.25 as described in U.S. Pat. No. 6,197,877.

Dispersant J** contains 0.19 parts Dispersant I with 0.01 parts polyphosphoric acid.

Dispersant K** contains 0.19 parts Dispersant I with 0.01 parts ortho phosphoric acid.

The results in Table 7 clearly show that the dispersants having a high ratio of phosphorus atoms relative to the polyester chain made according to the invention given more fluid dispersions than those using a dispersant made according to U.S. Pat. No. 6,197,877 which contain a low ratio of phosphorus atoms to polyester chain. Comparative examples Q and R show that the higher fluidity of Examples 26 and 27 is not attributable to either free pyrophosphoric acid or free ortho phosphoric acid.

1. A dispersant which comprises the reaction product of a phosphating agent and a compound of formula 1
R—OH 1
wherein the ratio of each atom of phosphorus in the phosphating agent to the compound of formula 1 is not less than 1.3:1, including mixtures and salts thereof; and wherein
R is a residue of a polyester and/or polyether having a polymerisation terminating group:

2. A dispersant as claimed in claim 1 wherein the ratio of each atom of phosphorus in the phosphating agent to the compound of formula 1 is not less than 1.8:1.

3. A dispersant as claimed in claim 1 wherein the ratio of each atom of phosphorus of the phosphating agent to each compound of formula 1 is not greater than 3:1.

4. A dispersant as claimed in claim 1 wherein the phosphating agent is either P₂O₅ or polyphosphoric acid.

5. A dispersant as claimed in claim 1 wherein the number-average molecular weight of R—OH is not less than 200.

6. A dispersant as claimed in claim 1 wherein the number-average molecular weight of R—OH is not greater than 10,000.

7. A dispersant as claimed in claim 1 wherein the polyester and/or polyether moiety of R—OH is attached to the polymerisation terminating group via an amino, mercapto or preferably a hydroxy group.

8. A dispersant as claimed in claim 1 wherein the compound of formula 1 is a compound of formula 2
TO-(CO-A-O)ₙ(BO)ₘ H₂
wherein
T is a polymerisation terminating group;
A is C₁₋₃₀-alkylene or C₂₋₃₀-alkenylene;
B is C₂₋₄-alkylene;
n and m are each, independently, from 0 to 500; and
n+m is not less than 4;
including salts and mixtures thereof.

9. A dispersant as claimed in claim 8 wherein (CO-A-O)ₙ is the residue of two or more different hydroxy carboxylic acids or lactones thereof.

10. A dispersant as claimed in claim 8 wherein (B-O)ₘ is the residue of two or more different alkylene oxides.

11. A dispersant as claimed in claim 8 wherein T is aryl, heteroaryl, aralkyl, cycloalkyl or alk(en)yl which may be linear or branched and where T may be optionally substituted.

12. A dispersant as claimed in claim 8 wherein T contains not greater than 50 carbon atoms.

13. A dispersant as claimed in claim 8 wherein T is phenyl or naphthyl optionally substituted by C₁₋₂₀-alkyl (linear or branched), C₁₋₁₂-alkoxy (linear or branched) or phenoxy; or C₁₋₃₆-alkyl which may be linear or branched and optionally substituted by halogen or C₁₋₆-alkoxy.

14. A dispersant as claimed in claim 8 wherein (CO-A-O)ₙ is derived from glycolic acid, 5-hydroxy valeric acid, 6-hydroxy caproic acid, ricinoleic acid, 12-hydroxystearic acid, 12-hydroxy dodecanoic acid, 5-hydroxy dodecanoic acid, 5-hydroxy decanoic acid, 4-hydroxy decanoic acid, β-propiolactone, δ-valerolactone, ε-caprolactone or C₁₋₆-alkyl substituted ε-caprolactone including mixtures thereof.

15. A dispersant as claimed in claim 8 wherein (B-O)ₘ is derived from propylene oxide, ethylene oxide or butylene oxide, including mixtures thereof and preferably ethylene oxide alone.

16. A dispersant as claimed in claim 1 which is a salt of an alkanolamine.

17. A process for making a dispersant as claimed in claim 1 which comprises reacting a compound of formula 1
R—OH 1
wherein
R is a residue of a polyester and/or polyether having a polymerisation terminating group:
with a phosphating agent at a temperature from 40° C. to 120° C. wherein the ratio of each phosphorus atom of the phosphating agent to the compound of formula 1 is not less than 1.5:1.

18. A composition comprising a particulate solid and a dispersant as claimed in claim 1.

19. A composition as claimed in claim 18 which additionally comprises a liquid medium.

20. A composition as claimed in claim 18 which additionally comprises a plastics material.

21. A composition as claimed in claim 20 wherein the plastics material comprises an unsaturated polyester resin or an acrylic resin.

22. A millbase, paint or ink comprising a particulate solid, film-forming binder resin, liquid medium and a dispersant as claimed in claim 1.
